(19) United States
(12) Patent Application Publication
(10) Pub. No.: US 2014/0270489 A1
(43) Pub. Date: Sep. 18, 2014

(54) LEARNED MID-LEVEL REPRESENTATION FOR CONTOUR AND OBJECT DETECTION

(71) Applicant: MICROSOFT CORPORATION, Redmond, WA (US)

(72) Inventors: Joseph Jaewhan Lim, Cambridge, MA (US); Piotr Dollar, Redmond, WA (US); Charles Lawrence Zitnick, III, Seattle, WA (US)

(73) Assignee: Microsoft Corporation, Redmond, WA (US)

(21) Appl. No.: 13/794,857

(22) Filed: Mar. 12, 2013

(51) Int. Cl. G06K 9/62

(52) U.S. Cl. CPC G06K 9/6256
USPC 382/159

(57) ABSTRACT

Various technologies described herein pertain to constructing mid-level sketch tokens for use in tasks, such as object detection and contour detection. Sketch patches can be extracted from binary images that comprise hand-drawn contours. The hand-drawn contours in the binary images can correspond to contours in training images. The sketch patches can be clustered to form sketch token classes. Moreover, color patches from the training images can be extracted and low-level features of the color patches can be computed. Further, a classifier that labels mid-level sketch tokens can be trained. Such training of the classifier can be through supervised learning of a mapping from the low-level features of the color patches to the sketch token classes.

### BACKGROUND

For visual recognition, mid-level features can provide a bridge between low-level pixel-based information and high-level concepts, such as object and scene level information. Effective mid-level representations can abstract low-level pixel information useful for later classification, while being invariant to irrelevant and noisy signals. The mid-level features can serve as a foundation of both bottom-up processing, such as object detection, and top-down tasks, such as contour classification or pixel-level segmentation from object class information.

Some conventional approaches include hand-designing mid-level features. For instance, edge information oftentimes is used to design mid-level features. This may be because humans can interpret line drawings and sketches. Techniques such as scale-invariant feature transform (SIFT) and histogram of oriented gradients (HOG) employ mid-level features that are hand designed using gradient and edge-based features. Further, early edge detectors were commonly used to find more complex shapes, such as junctions, straight lines, and curves, and were oftentimes applied to object recognition, structure from motion, tracking, and 3D shaped recovery.

Moreover, various conventional approaches learn mid-level features with or without supervision. For instance, some conventional approaches employ object level supervision to learn edge-based features or class-specific edges. Moreover, other traditional approaches utilize representations based on regions. Still other conventional techniques learn representations directly from pixels via deep networks, either without supervision or using object-level supervision. Learned features in these conventional approaches can resemble edge filters in early layers and more complex structures in deeper layers.

### SUMMARY

Described herein are various technologies that pertain to constructing mid-level sketch tokens for use in tasks, such as object detection and contour detection. Sketch patches can be extracted from binary images that comprise hand-drawn contours. The hand-drawn contours in the binary images can correspond to contours in training images. The sketch patches can be clustered to form sketch token classes. Moreover, color patches from the training images can be extracted and low-level features of the color patches can be computed. Further, a classifier that labels mid-level sketch tokens can be trained. Such training of the classifier can be through supervised learning of a mapping from the low-level features of the color patches to the sketch token classes.

According to various embodiments, the sketch token classes that are constructed can be used for tasks, such as object detection and contour detection. For instance, an input image can be received and image patches can be extracted from the input image. Further, low-level features of the image patches can be computed. The classifier trained through supervised learning from the hand-drawn contours can thereafter be utilized to detect, based upon the low-level features, sketch token classes to which each of the image patches belong. According to an example, a contour in the input image can be detected based upon the sketch token classes of the image patches. Additionally or alternatively, an object in the input image can be detected based upon the sketch token classes of the image patches, for example. Following this example, the low-level features and the sketch token classes of the image patches can be provided to a second classifier. The second classifier can responsively provide an output. Based upon the output of the second classifier, the object in the input image can be detected.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that learns local edge-based mid-level features.

FIG. 2 illustrates various exemplary sketch token classes learned from hand-drawn sketches.

FIG. 3 illustrates an exemplary representation of a training image and a corresponding binary image.

FIG. 4 illustrates exemplary self-similarity features of a color patch.

FIG. 5 illustrates an exemplary visual recognition system.

FIG. 6 illustrates an exemplary system that detects contours in an input image based upon identified mid-level sketch tokens.

FIG. 7 illustrates an exemplary system that detects an object in an input image based upon identified mid-level sketch tokens.

FIG. 8 is a flow diagram that illustrates an exemplary methodology of constructing a set of mid-level sketch token classes.

FIG. 9 is a flow diagram that illustrates an exemplary methodology of detecting sketch token classes utilizing a classifier trained through supervised learning from hand-drawn contours.

FIG. 10 illustrates an exemplary computing device.

### DETAILED DESCRIPTION

Various technologies pertaining to learning mid-level features based on image edge structures are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As set forth herein, local edge-based mid-level features can be learned through supervised learning from hand-drawn contours. The local edge-based mid-level features can be utilized for either, or both, bottom-up and top-down tasks. The mid-level features, referred to herein as sketch tokens, can capture local edge structure. Classes of sketch tokens can range from standard shapes, such as straight lines and junctions, to richer structures, such as curves and sets of parallel lines.

Given a vast number of potential local edge structures, an informative subset of the local edge structures can be selected through clustering to be represented by the sketch tokens. Sketch token classes can be defined using supervised mid-level information. In contrast to conventional approaches that use hand-defined classes, high-level supervision, or unsupervised information, the supervised mid-level information is obtained from human-labeled edges in natural images. The human-labeled data can be generalized since it is not object-class specific. Sketch patches centered on contours can be extracted from the hand-drawn sketches and clustered to form the sketch token classes. Accordingly, a diverse representative set of sketch tokens can result. It is contemplated, for instance, that between ten and a few hundred sketch tokens can be utilized, which can capture many commonly occurring local edge structures.

The occurrence of sketch tokens can be efficiently predicted given training images. A data-driven approach that classifies color patches from the training images with a token label given a collection of low-level features including oriented gradient channels, color channels, and self-similarity channels can be employed. The sketch token class assignments resulting from clustering the sketch patches of hand-drawn contours provide ground truth labels for training. This multi-class problem can be solved using a classifier (e.g., a random forest classifier). Accordingly, an efficient approach that can compute per pixel sketch token labeling can result.

Referring now to the drawings, FIG. 1 illustrates a system 100 that learns local edge-based mid-level features. The system 100 includes a learning system 102 that uses supervised mid-level information to train a classifier 116. The learning system 102 receives training images 104 and binary images 106. For instance, the training images 104 and the binary images 106 can be retrieved by the learning system 102 from a data repository (not shown). The binary images 106 include hand-drawn contours, where the hand-drawn contours in the binary images 106 correspond to contours in the training images 104. For instance, the binary images 106 can be generated by asking human subjects to divide each of the training images 104 into pieces, where each piece represents a distinguished thing in the image. Thus, the learning system 102 can learn mid-level features based on image edge structures using the training images 104 with hand-drawn contours from the binary images 106 to define classes of edge structures (e.g., straight lines, T-junctions, Y-junctions, corners, curves, parallel lines, etc.). Further, the learning system 102 can learn the classifier 116 that maps color image data (e.g., from the training images 104) to the classes of edge structures.

The learning system 102 further includes an extractor component 108 that extracts sketch patches from the binary images 106. A sketch patch is a patch of a fixed size from one of the binary images 106. For example, a size of a sketch patch can be greater than 8-by-8 pixels. Pursuant to another example, a size of a sketch patch can be 31-by-31 pixels. It is contemplated, however, that other patch sizes are intended to fall within the scope of the hereto appended claims (e.g., 8-by-8 pixels or smaller, etc.).

The learning system 102 further includes a cluster component 110 that clusters the sketch patches to form sketch token classes. The cluster component 110 can define the sketch token classes, which can be learned from the hand-drawn contours included in the binary images 106. The sketch patches that are clustered by the cluster component 110 (e.g., to form the sketch token classes) respectively include a labeled contour at a center pixel of such sketch patches. Thus, sketch patches centered on contours can be clustered to form the set of sketch token classes, whereas patches from the binary images 106 that lack a contour at a center pixel can be discarded (or not extracted by the extractor component 108).

The extractor component 108 can further extract color patches from the training images 104. A color patch is a patch of a fixed size from one of the training images 104. Again, for example, a size of a color patch can be greater than 8-by-8 pixels. Pursuant to another example, a size of a color patch can be 31-by-31 pixels. By way of example, a sketch patch size and a color patch size can be equal; yet, the claimed subject matter is not so limited. It is contemplated, however, that other patch sizes are intended to fall within the scope of the hereto appended claims (e.g., 8-by-8 pixels or smaller, etc.).

The learning system 102 also includes a feature evaluation component 112 that computes low-level features of the color patches. The low-level features of the color patches can include color features, gradient magnitude features, gradient orientation features, color self-similarity features, gradient self-similarity features, a combination thereof, and so forth.

Moreover, the learning system 102 includes a trainer component 114 that trains the classifier 116. Upon being trained, the classifier 116 can label mid-level sketch tokens. The trainer component 114 can train the classifier 116 through supervised learning of a mapping from the low-level features of the color patches to the sketch token classes. According to an example, the classifier 116 can be a random forest classifier.

With reference to FIG. 2, illustrated are various exemplary sketch token classes learned from hand-drawn sketches (e.g., the hand-drawn contours in the binary images 106). A set of sketch token classes that represent a variety of local edge structures which may exist in an image can be defined (e.g., by the cluster component 110 of FIG. 1). The sketch token classes can include a variety of sketch tokens, ranging from straight lines to more complex structures. As depicted, the sketch token classes can include straight lines, T-junctions, Y-junctions, corners, curves, parallel lines, etc. The sketch token classes can be represented based upon respective mean contour structures.

Turning to FIG. 3, illustrated is an exemplary representation of a training image 300 and a corresponding binary image 302. The binary image 302 includes hand-drawn contours (e.g., drawn by a human) that correspond to contours in the training image 300. The binary image 302 can have two possible values for each pixel included therein, whereas the training image 300 can be a color image. Also depicted is an exemplary color patch 304 included in the training image 300 and a corresponding sketch patch 306 included in the binary image 302.

Again, reference is made to FIG. 1. The learning system 102 can discover the sketch token classes using human-generated image sketches (e.g., the binary images 106). Assume that a set of training images I (e.g., the training images 104) with a corresponding set of binary images S (e.g., the binary images 106) representing the hand-drawn contours from the sketches are provided to the learning system 102.

The cluster component 110 can define the set of sketch token classes by clustering sketch patches s extracted from the binary images S. As noted above, examples of the sketch token classes resulting from such clustering are shown in FIG. 2. A sketch patch sⱼ extracted from a binary image Sᵢ can have a fixed size of 31-by-31 pixels, for example. Sketch patches that include a labeled contour at a center pixel thereof can be clustered by the cluster component 110 to form the sketch token classes.

Moreover, the cluster component 110 can cluster the sketch patches to form the sketch token classes by blurring the sketch patches as a function of a distance from a center pixel, where an amount of blurring of the sketch patches increases as the distance from the center pixel increases. The cluster component 110 can blur the sketch patches as a function of the distance from the center pixel by computing Daisy descriptors on binary contour labels included in the sketch patches. For instance, computation of the Daisy descriptors on the binary contour labels included in the sketch patch sⱼ can provide invariance to slight shifts in edge placement. Further, the cluster component 110 can cluster blurred sketch patches to form the sketch token classes. The cluster component 110, for instance, can perform clustering on the descriptors using a K-means algorithm. Accordingly, the K-means algorithm can be applied to cluster at the blurred sketch patches to form the sketch token classes. By way of example, the number of sketch token classes formed by the cluster component 110 clustering the sketch patches can be between 10 and 300. According to an example, 150 sketch token classes can be formed by the cluster component 110; following this example, k=150 clusters can be employed for the K-means algorithm when clustering the blurred sketch patches to form the sketch token classes. Moreover, it is also contemplated that fewer than 10 or more than 300 sketch token classes can be formed by the cluster component 110 when clustering the sketch patches.

Given the set of sketch token classes formed by the cluster component 110, it can be desired to detect occurrence of such sketch token classes in color images. The sketch token classes can be detected with a learned classifier (e.g., the classifier 116 trained by the trainer component 114). As input to the trainer component 114, features are computed by the feature evaluation component 112 from the color patches x extracted from the training images I (e.g., the training images 104), ground truth class labels are supplied by clustering results described above if the color patch is centered on a contour in the hand-drawn sketches S, otherwise the color patch is assigned to the background or no contour class. The input features extracted from the color image patches x used by the classifier 116 are described below.

The feature evaluation component 112 can analyze various types of low-level features. Examples of the low-level features that can be analyzed include self-similarity features. Self-similarity features can be color self-similarity features and/or gradient self-similarity features. Moreover, the type of low-level features evaluated by the feature evaluation component 112 of the color patches can include color features, gradient magnitude features, and/or gradient orientation features.

For feature extraction, the feature evaluation component 112 can create separate channels for each feature type. Each channel can have dimensions proportional to a size of an input image (e.g., the training images 104, etc.) and can capture a different facet of information. The channels can include color, gradient, and self-similarity information in a color patch xᵢ extracted from a color image (e.g., the training images 104).

For instance, three color channels can be computed by the feature evaluation component 112 using the CIE-LUV color space. Moreover, the feature evaluation component 112 can compute several gradient channels that vary in orientation and scale. Three gradient magnitude channels can be computed with varying amounts of blur. For instance, Gaussian blurs with standard deviations of 0, 1.5, and five pixels can be used by the feature evaluation component 112. Additionally, the gradient magnitude channels can be split based on orientation to create four additional channels, at two levels of blurring (e.g., 0 and 1.5), for a total of eight oriented magnitude channels.

As noted above, another type of feature used by the feature evaluation component 112 can be based on self-similarity. For instance, contours can occur at texture boundaries as well as intensity or color edges. The self-similarity features can capture portions of an image patch that include similar textures based on color and gradient information. The feature evaluation component 112 can compute texture information on an m-by-m grid over the color patch. According to an example, m=5 with patch boundary pixels being ignored. The texture of each grid cell j for a color patch x can be represented using a histogram Hⱼ over gradient or color features. Hⱼ can be computed by the feature evaluation component 112 separately for the color and gradient channels, which can have 3 and 11 dimensions respectively. The self-similarity feature θ is computed by the feature evaluation component 112 using the L1 distance metric between the histogram Hⱼ of grid cell j and the histogram Hₖ of grid cell k:

θⱼₖ=|Hⱼ−Hₖ|

Turning to FIG. 4, illustrated are exemplary self-similarity features of a color patch 400. A magnitude grid 402 shows histogram distances from an anchor cell 404 to other cells in the m-by-m grid for gradient magnitude histograms. Moreover, a color grid 406 shows histogram distances from an anchor cell 408 to other cells in the m-by-m grid for color histograms. It is to be appreciated, however, that the claimed subject matter is not limited by the example shown in FIG. 4.

Again, reference is made to FIG. 1, the self-similarity features θ can have m-by-m dimensions. However, since θⱼₖ=θₖⱼ and θⱼⱼ=0, a number of effective dimensions for a 5-by-5 grid is

$$( \begin{matrix}25 \\ 2\end{matrix} ) = 300.$$

Additionally, nearby patches can share self-similarity features. Hence, for computational efficiency, the self-similarity between a cell and its neighboring cells can be pre-computed by the feature evaluation component 112 and stored in m²−1=24 channels. Thus, storage and computational complexity can be relative to a number of features and pixels, rather than patch size.

In total, the feature evaluation component 112 can utilize 3 color channels, 3 gradient magnitude channels, 8 oriented gradient channels, 24 color self-similarity channels, and 24 gradient self-similarity channels, for a total of 62 channels. Computing the feature channels given an input image (e.g., the training images 104) can take a fraction of a second. It is to be appreciated, however, that the claimed subject matter is not limited to the foregoing.

As noted above, the classifier 116 can be a random forest classifier. The classifier 116 can be used for labeling sketch tokens in image patches. For instance, the classifier 116 can label each pixel in an image. Moreover, a number of potential classes for each patch can range in the hundreds, for example; yet, the claimed subject matter is not so limited. Accordingly, utilization of a random forest classifier can provide for efficiency when evaluating the multi-class problem noted above.

A random forest is a collection of decision trees whose results are averaged to produce a final result. According to an example, 200,000 contour patches and 100,000 no-contour patches can be randomly sampled for training each decision tree with the trainer component 114. The Gini impurity measure can be used to select a feature and decision boundary for each branch node from a randomly selected subset of possible features. Leaf nodes include the probabilities of belonging to each class and are typically sparse. A collection of 50 trees can be trained until every leaf node includes less than 15 examples. After the initial training phase for the random trees, class distributions can be re-estimated at nodes utilizing color patches from the training images 104.

With reference to FIG. 5, illustrated is a visual recognition system 500. The visual recognition system 500 includes a receiver component 502 that receives an input image 504. The visual recognition system 500 further includes the extractor component 108, the feature evaluation component 112, and the classifier 116 as described herein.

The extractor component 108 extracts image patches from the input image 504. According to an example, a patch size of the image patches can be larger than 8-by-8 pixels. According to another example, a patch size of the image patches can be 31-by-31 pixels. Yet, the claimed subject matter is not limited to the foregoing examples as it is contemplated that other patch sizes are intended to fall within the scope of the hereto appended claims (e.g., 8-by-8 pixels or smaller, etc.).

The feature evaluation component 112 can compute low-level features of the image patches. The low-level features of the image patches can include color features, gradient magnitude features, gradient orientation features, color self-similarity features, gradient self-similarity features, a combination thereof, and so forth.

Moreover, the classifier 116 is trained through supervised learning from hand-drawn contours as described herein (e.g., by the learning system 102 of FIG. 1). The classifier 116 can detect sketch token classes 506 to which each of the image patches belong based upon the low-level features computed by the feature evaluation component 112. The sketch token classes 506 to which each of the image patches belong, as determined by the classifier 116, can be used for various classification tasks. Examples of the classification tasks include object detection, contour classification, pixel level segmentation, and so forth.

Referring now to FIG. 6, illustrated is a system 600 that detects contours in the input image 504 based upon identified mid-level sketch tokens. The system 600 includes the receiver component 502, the extractor component 108, the feature evaluation component 112, and the classifier 116. Moreover, the system 600 includes a contour detection component 602 that detects a contour in the input image 504 based upon sketch token classes (e.g., the sketch token classes 506 of FIG. 5) of the image patches determined by the classifier 116.

The sketch token classes can provide an estimate of a local edge structure in an image patch. Moreover, contour detection performed by the contour detection component 602 can utilize binary labeling of pixel contours. Computing mid-level sketch tokens can enable the contour detection component 602 to accurately and efficiently predict low-level contours.

The classifier 116 can predict a probability that an image patch belongs to each sketch token class or a negative set. More particularly, for each pixel in the input image 504, the extractor component 108 can extract a given image patch centered on a given pixel from the input image 504. Further, the feature evaluation component 112 can compute low-level features of the given image patch. The classifier 116 can predict sketch token probabilities that the given image patch respectively belongs to each of the sketch token classes, and a probability that the given image patch belongs to none of the sketch token classes based upon the low-level features of the given image patch determined by the feature evaluation component 112. Moreover, a probability of the contour being at the given pixel can be computed by the contour detection component 602 as a sum of the sketch token probabilities. Further, the contour in the input image 504 can be detected based on the probability of the contour at the given pixel.

Since each sketch token has a contour located at its center pixel, the probability of a contour at the center pixel can be computed by the contour detection component 602 as a sum of the sketch token probabilities for the given image patch. If tᵢⱼ is a probability of patch xᵢ belonging to sketch token class j, and tᵢ₀ is the probability of belonging to the no-contour class (e.g., belonging to none of the sketch token classes), an estimated probability eᵢ of the patch's center including a contour is:

$${e}_{i} = {\sum }_{j} {t}_{ij} = 1 - {t}_{i 0}$$

Once the probability of a contour has been computed at each pixel, the contour detection component 602 can apply non-maximal suppression to find a peak response of a contour. The non-maximal suppression can be applied to suppress responses perpendicular to the contour. The orientation of the contour can be computed by the contour detection component 602 from the sketch token class with a highest probability using its orientation at the center pixel.

Now turning to FIG. 7, illustrated is a system 700 that detects an object in the input image 504 based upon identified mid-level sketch tokens. The system 700 includes the receiver component 502, the extractor component 108, the feature evaluation component 112, and the classifier 116.

The system 700 further includes an object detection component 702 and a second classifier 704. The object detection component 702 detects an object in the input image 504 based upon sketch token classes (e.g., the sketch token classes 506 of FIG. 5) of the image patches as determined by the classifier 116. The object detection component 702 can provide low-level features of the image patches and the sketch token classes of the image patches to the second classifier 704. The second classifier 704 can responsively provide an output. Moreover, the object detection component 702 can detect the object based upon the output of the second classifier 704. Examples of the second classifier 704 include a support vector machine (SVM), a neural network, a boosting classifier, and the like.

By way of illustration, for each pixel in the input image 504, the extractor component 108 can extract a given image patch centered on a given pixel from the input image 504. The feature evaluation component 112 can compute low-level features of the given image patch. According to an example, it is contemplated that the input image 504 can be up-sampled by a factor of two before feature computation by the feature evaluation component 112; yet, the claimed subject matter is not so limited. Moreover, the classifier 116 can predict sketch token probabilities that the given image patch respectively belongs to each of the sketch token classes, and a probability that the given image patch belongs to none of the sketch token classes based upon the low-level features of the given image patch determined by the feature evaluation component 112. The object detection component 702 can provide computed low-level features, sketch token probabilities, and probabilities of belonging to none of the sketch token classes for the pixels in the input image 504 to the second classifier 704. Based upon the output returned by the second classifier 704, the object detection component 702 can identify the object in the input image 504.

In contrast to conventional approaches, the object detection component 702 can provide additional channel features (e.g., sketch token classes) corresponding to the input image 504 to the second classifier 704. Such channel features can represent more complex edge structures which may exist in a scene. Accordingly, mid-level sketch tokens can be pooled with low-level features, such as color, gradient magnitude, oriented gradients, and so forth, and provided to the second classifier 704 for detection of the object.

FIGS. 8-9 illustrate exemplary methodologies relating to constructing and utilizing mid-level sketch tokens. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 8 illustrates a methodology 800 of constructing a set of mid-level sketch token classes. At 802, sketch patches can be extracted from binary images that comprise hand-drawn contours. The hand-drawn contours in the binary images can correspond to contours in training images. At 804, the sketch patches can be clustered to form sketch token classes. At 806, color patches from the training images can be extracted. At 808, low-level features of the color patches can be computed. At 810, a classifier that labels mid-level sketch tokens can be trained. The classifier can be trained through supervised learning of a mapping from the low-level features of the color patches to the sketch token classes.

Turning to FIG. 9, illustrated is a methodology 900 of detecting sketch token classes utilizing a classifier trained through supervised learning from hand-drawn contours. At 902, a given image patch centered on a given pixel can be extracted from an input image. At 904, low-level features of the given image patch can be computed. At 906, sketch token probabilities and a probability that the given image patch belongs to none of the sketch token classes can be predicted. The sketch token probabilities can be probabilities that the given image patch respectively belongs to each of the sketch token classes. The prediction can be effectuated utilizing the trained classifier based upon the low-level features of the given image patch. At 908, it can be determined whether there is a next pixel in the input image. If it is determined that there is a next pixel in the input image at 908, then the methodology 900 can return to 902 (e.g., extract a next image patch centered on the next pixel, compute low-level features of the next image patch, predict sketch token probabilities for the next image patch centered at the next pixel and a probability that the next image patch centered at the next token belongs to none of the sketch token classes, etc.). Alternatively, if it is determined that the sketch token probabilities and the probability that the given image patch belongs to none of the sketch token classes have been determined for each of the pixels in the input image, then the methodology 900 can continue to 910. At 910, object detection and/or contour detection can be performed based at least in part upon the probabilities predicted at 906.

Referring now to FIG. 10, a high-level illustration of an exemplary computing device 1000 that can be used in accordance with the systems and methodologies disclosed herein is illustrated. For instance, the computing device 1000 may be used in a system that learns mid-level sketch tokens based upon hand-drawn contours corresponding to contours in training images. By way of another example, the computing device 1000 can be used in a system that employs a classifier trained through supervised learning from hand-drawn contours to detect sketch token classes. The computing device 1000 includes at least one processor 1002 that executes instructions that are stored in a memory 1004. The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store training images, binary images, sketch token classes, input images, and so forth.

The computing device 1000 additionally includes a data store 1008 that is accessible by the processor 1002 by way of the system bus 1006. The data store 1008 may include executable instructions, training images, binary images, sketch token classes, input images, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

It is contemplated that the external devices that communicate with the computing device 1000 via the input interface 1010 and the output interface 1012 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1000 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1000 may be a distributed system. Thus, for instance, several devices may be in communication by way of a network connection and may collectively perform tasks described as being performed by the computing device 1000.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method, comprising:
extracting sketch patches from binary images that comprise hand-drawn contours, wherein the hand-drawn contours in the binary images correspond to contours in training images;
clustering the sketch patches to form sketch token classes;
extracting color patches from the training images;
computing low-level features of the color patches; and
training a classifier that labels mid-level sketch tokens, wherein the classifier is trained through supervised learning of a mapping from the low-level features of the color patches to the sketch token classes.

2. The method of claim 1, wherein the classifier is a random forest classifier.

3. The method of claim 1, wherein the sketch patches that are clustered to form the sketch token classes respectively comprise a labeled contour at a center pixel.

4. The method of claim 1, wherein clustering the sketch patches to form the sketch token classes further comprises:
blurring the sketch patches as a function of a distance from a center pixel, wherein an amount of blurring of the sketch patches increases as the distance from the center pixel increases; and
clustering blurred sketch patches to form the sketch token classes.

5. The method of claim 4, wherein blurring the sketch patches as a function of the distance from the center pixel further comprises computing Daisy descriptors on binary contour labels comprised in the sketch patches.

6. The method of claim 4, further comprising employing a K-means algorithm to cluster the blurred sketch patches to form the sketch token classes.

7. The method of claim 1, wherein a number of sketch token classes formed by clustering the sketch patches is between 10 and 300.

8. The method of claim 1, wherein a patch size of at least one of the sketch patches or the color patches is larger than 8-by-8 pixels.

9. The method of claim 1, wherein a patch size of at least one of the sketch patches or the color patches is 31-by-31 pixels.

10. The method of claim 1, wherein the low-level features of the color patches comprise self-similarity features.

11. The method of claim 1, wherein the low-level features of the color patches comprise at least one of color features, gradient magnitude features, gradient orientation features, color self-similarity features, or gradient self-similarity features.

12. The method of claim 1, further comprising detecting a contour in an input image utilizing the classifier as trained, comprising:
for pixels in the input image:
extracting a given image patch centered on a given pixel from the input image;
computing low-level features of the given image patch;
predicting sketch token probabilities that the given image patch respectively belongs to each of the sketch token classes and a probability that the given image patch belongs to none of the sketch token classes utilizing the classifier as trained based upon the low-level features of the given image patch; and
computing a probability of the contour at the given pixel as a sum of the sketch token probabilities, wherein the contour in the input image is detected based on the probability of the contour at the given pixel.

13. The method of claim 1, further comprising detecting an object in an input image utilizing the classifier as trained, comprising:
for pixels in the input image:
extracting a given image patch centered on a given pixel from the input image;
computing low-level features of the given image patch; and
predicting sketch token probabilities that the given image patch respectively belongs to each of the sketch token classes and a probability that the given image patch belongs to none of the sketch token classes utilizing the classifier as trained based upon the low-level features of the given image patch;
providing computed low-level features, sketch token probabilities, and probabilities of belonging to none of the sketch token classes for the pixels in the input image to a second classifier, wherein the second classifier produces an output; and
identifying the object in the input image based upon the output of the second classifier.

14. A computing device comprising a visual recognition system, the visual recognition system comprising:
a receiver component that receives an input image;
an extractor component that extracts image patches from the input image;
a feature evaluation component that computes low-level features of the image patches; and
a classifier trained through supervised learning from hand-drawn contours, wherein the classifier detects sketch token classes to which each of the image patches belong based upon the low-level features.

15. The computing device of claim 14, further comprising a contour detection component that detects a contour in the input image based upon the sketch token classes of the image patches.

16. The computing device of claim 14, further comprising an object detection component that detects an object in the input image based upon the sketch token classes of the image patches, wherein the object detection component provides low-level features and the sketch token classes of the image patches to a second classifier, wherein the second classifier responsively provides an output, and wherein the object detection component detects the object based upon the output of the second classifier.

17. The computing device of claim 14, wherein the classifier is a random forest classifier.

18. The computing device of claim 14, wherein a patch size of the image patches is larger than 8-by-8 pixels.

19. The computing device of claim 14, wherein the low-level features of the image patches comprise at least one of color features, gradient magnitude features, gradient orientation features, color self-similarity features, or gradient self-similarity features.

20. A computer-readable storage medium including computer-executable instructions that, when executed by a processor, cause the processor to perform acts including:
extracting sketch patches from binary images that comprise hand-drawn contours, wherein the hand-drawn contours in the binary images correspond to contours in training images;
blurring the sketch patches as a function of a distance from a center pixel by computing Daisy descriptors on binary contour labels comprises in the sketch patches;
clustering blurred sketch patches to form sketch token classes;
extracting color patches from the training images;
computing low-level features of the color patches, wherein the low-level features of the color patches comprise at least one of color features, gradient magnitude features, gradient orientation features, color self-similarity features, or gradient self-similarity features; and
training a random forest classifier that labels mid-level sketch tokens, wherein the random forest classifier is trained through supervised learning of a mapping from the low-level features of the color patches to the sketch token classes.
